(19) United States
(12) Patent Application Publication
(10) Pub. No.: US 2008/0106518 A1
(43) Pub. Date: May 8, 2008

(54) Tactile input arrangement for a computing device

(76) Inventor: Mark P. Orlassino, Centereach, NY (US)

Correspondence Address: FAY KAPLUN & MARCIN, LLP, 150 BROADWAY, SUITE 702, NEW YORK, NY, 10038, US

(21) Appl. No.: 11/592,664

(22) Filed: Nov. 3, 2006

(51) Int. Cl. G09G 5/00; G06F 3/02; G06F 3/033

(52) U.S. Cl. 345/161; 345/156; 345/168; 345/173; 345/167; 345/184

(57) ABSTRACT

Described is a tactile input arrangement for a computing device. A portable computing device comprises a housing, a first input arrangement forming at least a portion of a first external surface of the housing and receiving input data from a user and a second input arrangement forming at least a portion of a second external surface of the housing and receiving further input data from the user, the second external surface facing in a direction substantially opposite to the first external surface.

### FIELD OF THE INVENTION

The present invention relates generally to a tactile input arrangement for a computing device.

### BACKGROUND

Conventional mobile computing units (MUs) such as bar code scanners, mobile phones, PDAs, etc. include keypads and/or touch screens for receiving user input. For example, a user may hold the MU in one hand and press keys on the keypad or enter input on the touch screen with the other hand. Although these examples describe two-handed use of the MU, some operations (e.g., dialing a phone number) may be accomplished by single-handed use where the MU is held in the same hand that is used to enter input. For example, a user may hold the MU in his palm and reach his thumb around to press keys on the keypad. However, only a limited number of operations can be performed by single-handed use due to size/shape/weight of the MU, location of the keypad or touch screen, etc.

### SUMMARY OF THE INVENTION

The present invention relates to a tactile input arrangement for a computing device. A portable computing device comprises a housing, a first input arrangement forming at least a portion of a first external surface of the housing and receiving input data from a user and a second input arrangement forming at least a portion of a second external surface of the housing and receiving further input data from the user, the second external surface facing in a direction substantially opposite to the first external surface.

### DESCRIPTION OF THE DRAWINGS

FIG. 1 shows a front view of an exemplary embodiment of a mobile computing unit according to the present invention; and

FIG. 2 shows a rear view of an exemplary embodiment of a mobile computing unit according to the present invention.

### DETAILED DESCRIPTION

The present invention may be further understood with reference to the following description and the appended drawings, wherein like elements are referred to with the same reference numerals. The present invention describes a tactile input arrangement for a computing device. According to the exemplary embodiments of the present invention, the tactile input arrangement is disposed on an external surface of the computing device which is opposite a surface containing a display screen and/or a keypad. In this manner, when the computing device is held in a user's hand, the user may interface with the tactile input using, for example, a forefinger, and interface with the keypad and/or the display screen using a thumb. Thus, the exemplary embodiments of the present invention provide for single-handed operation of the computing device, allowing the user to maintain a free hand for other purposes.

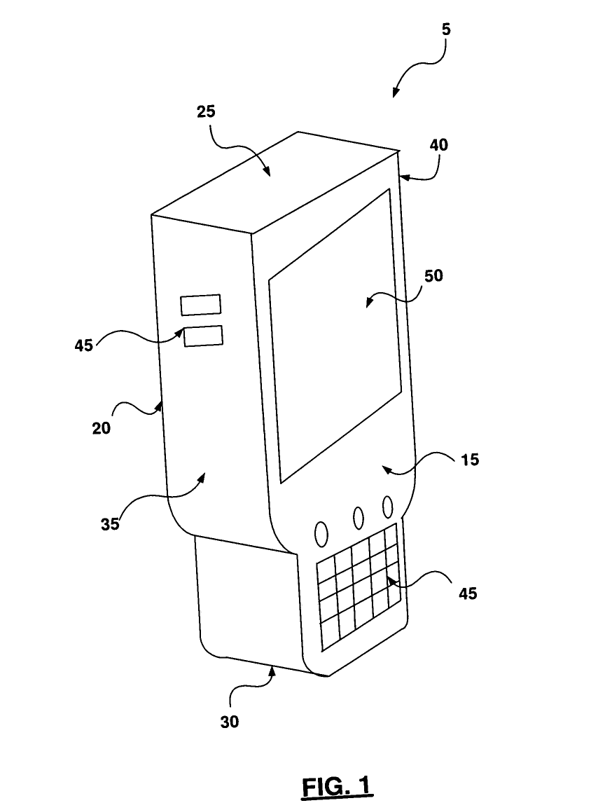

FIG. 1 shows an exemplary embodiment of a computing device according to the present invention. The computing device may be a mobile computing unit (MU) 5 which includes, for example, a laser-/imager-based scanner, an RFID reader, a mobile phone, a PDA, a digital camera, a digital media player, etc. The MU 5 may include various components (hardware and/or software) for performing functions typical of conventional MUs. For example, the MU 5 may include a processor, memory and circuitry for wireless and/or wired communications. The MU 5 may also include hardware/software specific components for performing specific tasks, e.g., scanning bar codes, querying RFID tags, etc.

The MU 5 includes a housing 10 comprising one or more structures which, as a composite structure, is generally rectangular in shape having three pairs of opposite sides, e.g., a front surface 15 opposite a rear surface 20, a top surface 25 opposite a bottom surface 30 and opposing side surfaces 35, 40. Those of skill in the art will understand that geometric shape and dimensions of the MU 5 may vary depending upon, for example, applications of the MU 5, portability, packaging, manufacturing, user-based requests, etc. For example, a digital media player may have an integrally formed housing, while a mobile communication device may include one structure housing a display screen and a second structure housing an alphanumeric keypad, control keys, etc.

The MU 5 includes at least one first input receiving arrangement such as, for example, a keypad 45 and/or a touch screen 50 disposed on the front surface 15 so that the first arrangements may be simultaneously viewable when entering data. The keypad 10 may be a conventional keypad including alphanumeric keys for entering data and, optionally, hot-keys for launching specific applications on the MU 5, controlling operation of the MU 5, etc. As is known in the art, one or more hot-keys may be disposed along one (or both) of the side surfaces 35, 40 of the MU 5. For example, hot-keys controlling an output volume of the MU 5 and/or a brightness level of the touch screen 50 may be disposed on the side surface 35 of the MU 5 so that, when the MU 5 is held in the user's palm, these settings can be adjusted with his thumb.

The touch screen 50 may be implemented using conventional touch screen technology (e.g., infrared, capacitive, inductive, etc.) and receive user input via the user's finger and/or a stylus. The touch screen 50 may be used in conjunction with or exclusive of the keypad 45. For example, the MU 5 may not include the keypad 45 if the touch screen 50 is configured to present an alphanumeric keypad. In another embodiment, the MU 5 may include a passive display screen rather than the touch screen 50, and user input may be exclusively received via the keypad 45.

The touch screen 50 and the keypad 45 may be disposed on substantially the same surface of the MU 5 (e.g., on the front surface 15) so that when the user is interfacing with the MU 5 both the touch screen 50 and the keypad 45 are simultaneously viewable. While the exemplary embodiment of FIG. 1 shows the MU 5 as being formed as an integral unit, those of skill in the art will understand that the touch screen 50 may be disposed on a first structure which is physically coupled to a second structure housing the keypad 45. For example, the first and second structures may be hingedly, rotatably, or slidably connected, allowing the MU 5 to have a lower profile and take up less space. While not being disposed on the same surface in these embodiments, the touch screen 50 and the keypad 45 may be disposed in substantially the same plane when, for example, the keypad 45 is being used to enter text.

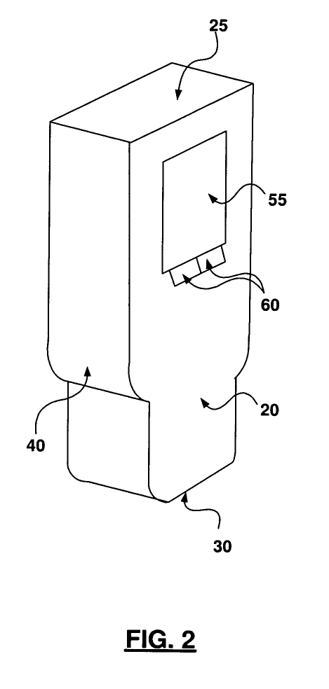

FIG. 2 shows an exemplary embodiment of the rear surface 20 of the MU 5 according to the present invention which includes a second input receiving arrangement. In the exemplary embodiment, the second input receiving arrangement is a touch pad 55 which receives and interprets tactile input. The user may trace movements on the touch pad 55 to move a cursor shown on the touch screen 50. Those of skill in the art will understand that, in other exemplary embodiments, the second input receiving arrangement may be, for example, a joystick, a ball, a wheel, a switch, a button(s), etc. The touch pad 55 may have any shape and/or size and be disposed on any portion of the rear surface 20. Preferably, the touch pad 55 is positioned so that when the MU 5 is held in the user's palm, the user's forefinger can easily reach over an entire area of the touch pad 55.

The user may input a predetermined tactile sequence (e.g., a double-tap) on the touch pad 55 to select items shown on the touch screen 50. The touch pad 55 may also be responsive to pressure changes and/or traced movements for adjusting volume, screen brightness/contrast, etc. For example, the user may select a volume control icon presented on the touch screen 50 using the double-tap sequence and then trace a line on the touch pad 55 indicative of an increase or decrease in the volume. Optionally, one or more selectors 60 may be disposed on the rear surface 20 of the MU 5 adjacent the touch pad 55 so that, once the cursor is positioned over a desired item on the touch screen 50, the user may engage one of the selectors 60 to select the item. The selectors 60 may be, for example, buttons, dials, switches, knobs, etc.

The user may prevent inadvertent touches on the touch pad 55 by utilizing a lock mechanism. For example, when the user is scanning bar codes or carrying the MU 5, an inadvertent touch of the touch pad 20 may unintentionally launch an application or select an item. The user may be required to stop a current activity to reset the MU 5. Or, the user may believe that the MU 5 is malfunctioning because no intentional tactile input was provided.

In one exemplary embodiment, the lock mechanism may be an electronic lock whereby the touch pad 55 may be selectively enabled/disabled by the user and/or automatically after a predetermined time period. A predetermined tactile sequence, an authorization code entered via the keypad 45, a gesture input, etc. may be utilized to enable/disable the touch pad 55. In another exemplary embodiment, a timer may be initialized to a predetermined time period which, upon expiration, sends a signal to the processor of the MU 5 to cease receiving input from the touch pad 55. The user may “wake up” the touch pad 55 to receive tactile input using the predetermined tactile sequence, the authorization code, etc. As understood by those of skill in the art, the lock mechanism may be employed for the first and/or second input arrangements so that the user can selectively activate the first and second input arrangements to receive input.

In another exemplary embodiment, the locking mechanism may be a physical lock which prevents access to the touch pad 55. For example, the physical lock may be a hard cover which attaches to the rear surface 20 of the MU 5 and covers the touch pad 55. In this embodiment, the touch pad 55 may receive tactile input while the MU 5 is powered and require the user to cover the touch pad 55 to prevent inadvertent input. The hard cover may be a separate item or be coupled to the MU 5 via a hinge (door-like), a sliding cover (window-like), etc.

Those of skill in the art will understand that the exemplary embodiments of the present invention may provide for true-single handed use of the MU 5. That is, when the MU 5 is held in the user's palm, the user may interface with the MU 5 by providing tactile input to the touch pad 55 with his forefinger. Tracing a movement on the touch pad 55 results in a corresponding movement of a cursor on the touch screen 50. Double-tapping on or applying pressure to the touch pad 55 may indicate a selection of an item, while tracing movements may adjust values, scroll through content presented on the touch screen 50, etc.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A portable computing device, comprising:
a housing;
a first input arrangement forming at least a portion of a first external surface of the housing and receiving input data from a user; and
a second input arrangement forming at least a portion of a second external surface of the housing and receiving further input data from the user, the second external surface facing in a direction substantially opposite to the first external surface.

2. The device according to claim 1, wherein the device includes at least one of an imager-based scanner, a laser-based scanner, an RFID reader, a mobile phone, a digital media player and a digital camera.

3. The device according to claim 1, wherein the device includes a communications arrangement for conducting at least one of wired and wireless communications.

4. The device according to claim 1, wherein the first input arrangement includes at least one of a touch screen, a keypad and a microphone.

5. The device according to claim 1, wherein the first external surface is a substantially flat outer surface of the housing.

6. The device according to claim 1, wherein the input data includes at least one of a tactile input and a voice command.

7. The device according to claim 1, wherein the second input arrangement includes at least one of a touch pad, a joystick, a roller ball, a wheel, a switch and a button.

8. The device according to claim 1, wherein the second external surface is a substantially flat rear surface of the housing.

9. The device according to claim 1, wherein the further input data includes at least one of a tactile input and a gesture input.

10. The device according to claim 1, wherein the second input arrangement switches between locked and unlocked states so that when in the locked state, the further input data is ignored by the device.

11. The device according to claim 10, wherein the second input arrangement switches between the locked and unlocked states as a function of a predetermined input sequence received by the second input arrangement.

12. The device according to claim 11, wherein the predetermined input sequence includes at least one of a predetermined tactile input and a predetermined gesture input.

13. The device according to claim 1, further comprising:
a cover removably covering the second input arrangement.

14. The device according to claim 1, further comprising:
a display displaying the input data and the further input data simultaneously.

15. A computing device, comprising:
a processor receiving input data from a first input arrangement disposed on a first external surface of the device and further input data from a second input arrangement disposed on a second external surface of the device, the second external surface facing in a direction substantially opposite to the first external surface; and
a display screen displaying at least one of the input data and the further input data.

16. The device according to claim 15, wherein the processor selectively processes at least one of the input data and the further input data as a function of a command signal.

17. The device according to claim 16, wherein the command signal is one of a predetermined tactile sequence and a predetermined gestured sequence input to one of the first and second input arrangements.

18. The device according to claim 1, wherein the first input arrangement includes at least one of a touch screen, a keypad and a microphone and the second input arrangement includes at least one of a touch pad, a joystick, a roller ball, a wheel, a switch and a button.

19. An input arrangement for a mobile computing device, comprising:
a first tactile input device disposed on a first external surface of the device, the first external surface facing a direction substantially opposite to a second external surface, a display screen being disposed on the second external surface; and
a second tactile input device disposed on the first external surface of the device adjacent the first tactile input device.

20. A device, comprising:
a housing means;
a first input arrangement means for receiving input data from a user and forming at least a portion of a first external surface of the housing; and
a second input arrangement means for receiving further input data from the user and forming at least a portion of a second external surface of the housing, the second external surface facing in a direction substantially opposite to the first external surface.
